(19) United States
(12) Patent Application Publication
(10) Pub. No.: US 2005/0098454 A1
(43) Pub. Date: May 12, 2005

(54) Holders for fastening digital media discs to fabric surfaces

(76) Inventors: Christopher M. Gallant, Nottingham, NH (US); Howard A. Kingsford, Amherst, NH (US)

Correspondence Address: FISH & RICHARDSON PC, 225 FRANKLIN ST, BOSTON, MA, 02110, US

(21) Appl. No.: 10/921,684

(22) Filed: Aug. 19, 2004

Related U.S. Application Data
(60) Provisional application No. 60/496,622, filed on Aug. 20, 2003.

(51) Int. Cl. B32B 3/02; B65D 85/30; B65D 85/57

(52) U.S. Cl. 206/308.1

(57) ABSTRACT

Holders for digital media discs are provided. The holders are configured to allow one or more digital media disc(s) to be mounted on a fabric surface, for example a fabric surface within the interior of a vehicle or the wall of a cubicle.

### CROSS-REFERENCE TO RELATED APPLICATIONS

This application claims the benefit prior U.S. Provisional Application No. 60/496,622, filed Aug. 20, 2003, which is incorporated herein by reference in its entirety.

### TECHNICAL FIELD

This invention relates to holders for fastening digital media discs to fabric surfaces. The invention also relates to methods of using such holders.

### BACKGROUND

Recently, compact disc (CD) players have become increasingly common in cars and other motor vehicles. Players for reading other types of digital media, e.g., DVDs, are also becoming more common. Users of such players generally wish to store a number of digital media discs (e.g., CDs and/or DVDs) in the vehicle, so as to have a selection of music available while driving. Sometimes CDs are stored, in their original “jewel” cases, in the glove compartment or other closed compartments within the vehicle. Such storage takes up space in the compartment(s) and tends to make it difficult to access a CD while driving. CDs may also be stored in portable cases, for example fabric cases that secure to the sun-visor of the vehicle.

### SUMMARY

The present invention provides holders for digital media discs that allow such discs to be mounted on a fabric surface, for example, the headliner of a vehicle, allowing one or more discs to be mounted within easy reach of the driver, and to be easily removed and replaced. The holders allow the discs to be decoratively displayed within the interior of the vehicle, while also providing easy access to the discs by the driver or passenger.

In one aspect, the invention features a holder for one or more digital media discs, including (a) a base, (b) a feature configured to releasably hold the disc(s), extending from a first surface of the base, and (c) an array of fastener elements extending from a second, opposite surface of the base, the fastener elements being configured to engage a fabric substrate.

Some implementations include one or more of the following features. The fastener elements include male fastener elements. The feature is configured to hold a plurality of discs. The holder further includes one or more additional features, extending from the first surface of the base at spaced intervals and configured to hold additional discs. The fastener elements extend integrally from the base. The fastener elements include hooks and/or mushrooms. The fastener elements include loop-engageable elements. The base has a diameter smaller than the diameter of the disc. The feature includes a snap feature configured to extend through a central opening in the disc. The snap feature may include a plurality of resilient fingers. The feature may include a compressible foam. The feature has a height of at least about 0.5 mm, e.g., about 1 to 5 mm. The base has a thickness of about 0.5 to 5.0 mm. The feature extends integrally from the sheet-form base. The fastener elements are configured to be releasable from the substrate.

In a further aspect, the invention features methods of using the holders to mount digital media discs on loop bearing surfaces, such as fabric substrates.

For example, in one aspect, the invention features a method of securing a digital media disc to a loop-bearing substrate including (a) releasably securing a holder having a first surface bearing an array of male fastener elements to the substrate, by engaging the male fastener elements with loops extending from the substrate; and (b) releasably mounting the digital media disc on a second surface of the holder.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 is a perspective view of a CD holder according to one aspect of the invention.

FIG. 2 is a partial diagrammatic perspective view of the passenger compartment of a car, with a plurality of CD holders mounted on the headliner.

FIG. 3 is a cross-sectional view showing a CD holder of FIG. 1 mounted on a headliner and holding a CD.

FIG. 4 is a perspective view of a CD holder according to an alternative embodiment of the invention.

FIG. 4A is a side view of the CD holder of FIG. 4, with a CD in place on the holder. FIG. 4B is an enlarged detail side view of a portion of the CD holder of FIG. 4.

FIG. 5 is a perspective view of a CD holder according to another alternative embodiment.

FIG. 6 is a perspective view of a CD holder according to yet another alternative embodiment. FIG. 6A is an enlarged detail side view of a portion of the CD holder of FIG. 6.

FIG. 7 is a perspective view of a CD holder according to a further alternative embodiment.

FIG. 8 is a perspective view of a CD holder configured to hold multiple CDs side-by-side, with one CD in place on the holder.

Like reference symbols in the various drawings indicate like elements.

### DETAILED DESCRIPTION

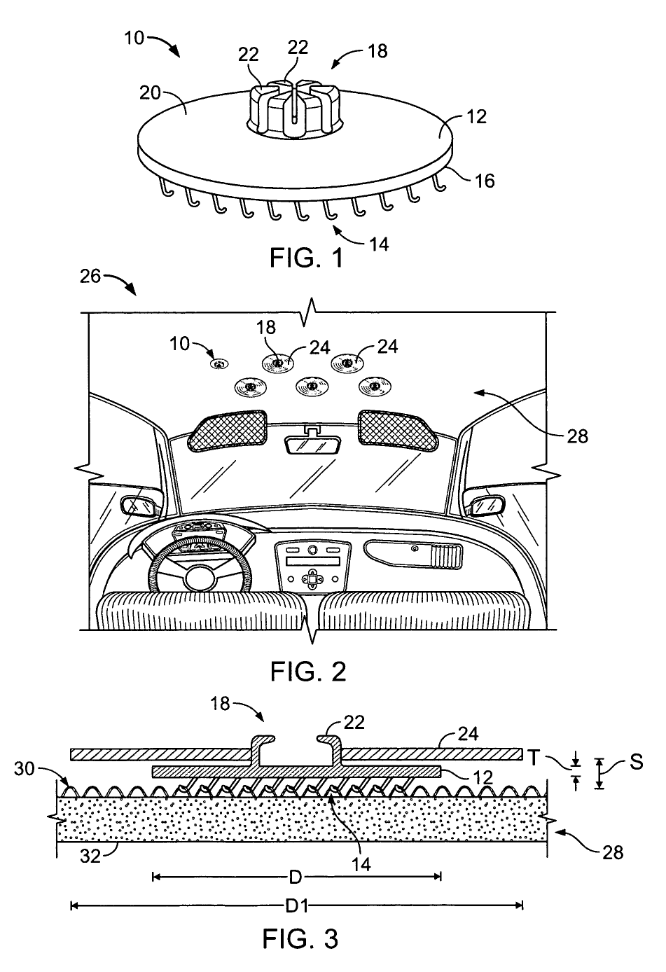

Referring to FIG. 1, a CD holder 10 includes a disc-shaped sheet-form body 12, an array of male fastener elements 14, extending from one surface 16 of the body, and a snap feature 18 extending from the opposite surface 20 of the body. Male fastener elements 14 are suitable for use in a hook-and-loop fastener, e.g., fasteners that are commercially available under the tradename VELCRO®. The fastener elements may include hooks and/or other types of male fastener elements, for example mushroom-shaped or disc-shaped fastener elements.

In the embodiment shown in FIG. 1, the snap feature 18 includes a plurality of resilient fingers 22. Resilient fingers 22 are configured to deform inward when a CD 24 is pressed down onto the snap feature 18, and then spring back against the walls of the central opening of the CD to hold the CD in place, as shown in FIG. 3. The CD may be removed by pulling gently upwards on the perimeter of the CD to press the fingers 22 together and release the CD from the snap feature. Alternatively, the user can push gently on the fingers to release the CD.

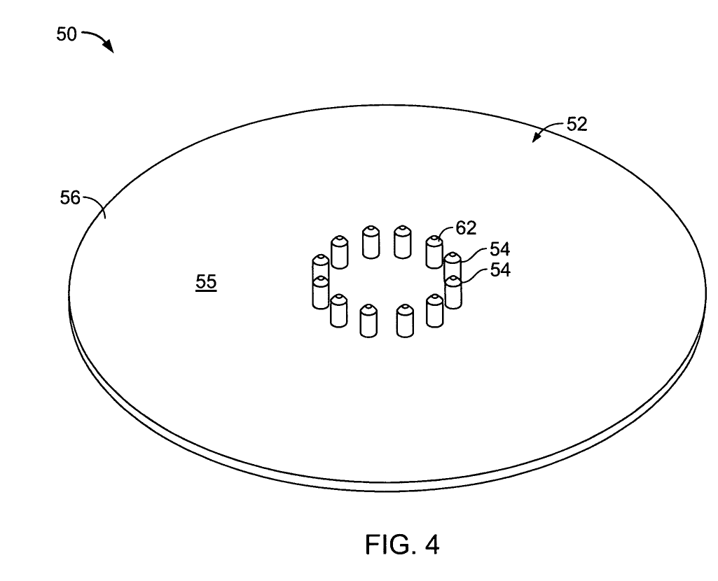

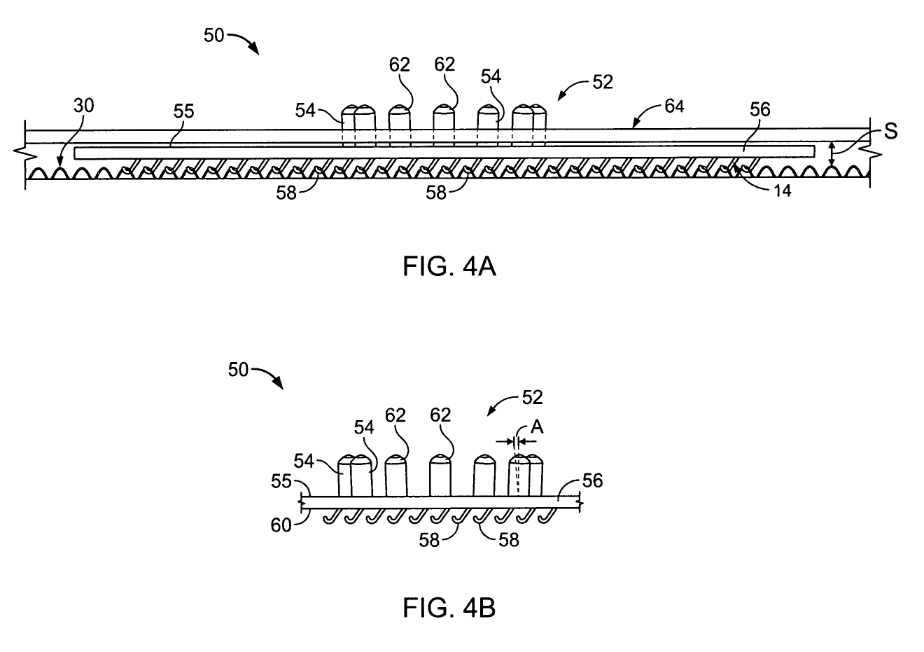

As shown in FIG. 4, when a person wishes to use the CD holder 10 to store a CD in a vehicle interior 26, the person applies the CD holder to the headliner 28 of the vehicle interior, and then applies a CD to the CD holder as discussed above. The CD holder can be applied and removed, and positioned and repositioned on the headliner, as desired by the user. Multiple CD holders can be used to store multiple CDs, as shown in FIG. 4.

Referring to FIG. 3, the CD holder 10 is applied to the headliner 28 by engaging the male fastener elements 14 with the loop-like fabric surface 30 of the headliner 28. Typically, a headliner is formed of a hook-receptive fabric mounted on a rigid backing 32, as shown. Fabrics that are typically used for headliners include Guilford headliner fabrics.

The array of male fastener elements may have any desired characteristics. It is preferred that the male fastener elements be configured to provide good engagement strength while minimizing damage to the headliner fabric. The engagement strength will depend on the geometry of the male fastener elements, the density of the fastener array, and the size of the fastener array. It is preferred that the engagement strength of the CD holder be sufficient to prevent the CD holder from falling off of the headliner when the vehicle is driven over a bumpy road, and to prevent the CD holder from releasing from the headliner when a CD is removed from the CD holder. Suitable male fastener elements are described, for example, in U.S. Pat. No. 5,900,350, the disclosure of which is incorporated herein by reference. An example of a commercially available product that includes a suitable array of male fastener elements is HTH 833 hook tape fastener tape, available from Velcro USA.

Preferably, the array has a relatively high hook density, e.g., at least 500 hooks/in². In the case of small hooks, for example hooks having a height, measured from the base to the highest point of the hook, of less than 0.4 mm, it is generally preferred that the array have a higher hook density, e.g., at least 1500 hooks/in.² It is also generally preferred that the hooks be relatively flexible, to minimize damage to the headliner fabric.

The engagement strength of the CD holder with the headliner fabric should generally be sufficiently high so that the CD holder will not fall down during normal driving conditions, and will not come off of the headliner when a CD is removed from the snap feature. Thus, the engagement strength should typically be significantly greater than the engagement strength between the CD and the snap feature. On the other hand, it is generally preferred that the engagement strength be low enough so that the CD holder can be removed from the headliner fabric without significant damage to the headliner fabric.

As shown in FIG. 3, the sheet-form body 12 of the CD holder 10 may have a diameter D that is significantly smaller than the diameter D1 of the CD. Diameter D should be somewhat larger than the hole in the center of the CD, to accommodate the snap feature 18, and sufficiently large to provide adequate engagement strength of the array of male fastener elements with the headliner fabric. For example, diameter D may be from about 15 to 60 mm. A small diameter sheet-form body will generally result in a relatively low cost product that is convenient to package, ship, and store.

However, if desired, diameter D may be equal to or greater than the diameter D1 of the CD. For example, if desired surface 20 of the sheet-form body may carry text and/or graphics, to enhance the decorative effect of the CD holder when it is not holding a CD. In this case, it may be desirable for diameter D to be relatively large, to accommodate a larger graphic design. Moreover, it may be desirable for the body 12 to have a diameter larger than that of the CD to minimize contact between the user's fingers and the headliner, to reduce transfer of dirt and oils to the headliner.

The sheet-form body 12 may be flexible, semi-rigid, or rigid, and may have any desired thickness. For example, the sheet-form body 12 may have a thickness T (FIG. 3) of about 0.5 to 5.0 mm, e.g., about 0.8 to 2.5 mm. If the body 12 has a relatively large diameter, it may be desirable to form the body of a flexible material, to allow the sheet-form body to conform to the shape of the headliner. However, the body should generally be sufficiently rigid so as to minimize distortion of the snap feature which could interfere with engagement of the snap feature with a CD. It also may be preferred that standoff S (FIG. 3), i.e., the distance between the surface of the headliner and the opposed surface of the CD, be sufficiently large so that a user can slip the tip of his or her finger between the CD and the surface of the headliner to remove the CD from the CD holder. To allow the user to do this, the standoff S would typically be at least 2.5 mm. The standoff is generally determined primarily by the thickness T of the body 12, so if a certain standoff is desired this consideration may affect the thickness selected when designing a CD holder. However, because the CD can be removed by pressing gently on fingers 22, the standoff can be smaller, e.g., if a thin body is desired.

The resilient fingers 22 function in a manner similar to the small fingers that are provided in the center of a “jewel case” for storing a CD. However, generally the fingers of the snap feature need to provide a greater spring force, to resist the force of gravity acting on the CD as well as the jarring and bouncing encountered when the vehicle is driven on rough roads. Thus, the fingers are preferably relatively large, for example they may extend from about 1 to 5 mm above surface 20 of the sheet-form body.

The opening in the center of a CD or other digital media disc is typically about 15 mm±0.1 mm. Thus, it is generally preferred that the snap feature have a diameter of about 14-15 mm.

The CD holder may be manufactured by any desired process. For example, the CD holder may be injection molded, e.g., using the processes described in U.S. Pat. No. 6,224,364, the entire disclosure of which is incorporated herein by reference. Alternatively, the CD holder may be formed by first producing a sheet material carrying male fastener elements, using any desired process, and subsequently adding the snap feature. In this case, the snap feature may be added, for example, by thermoforming the sheet material, by insert molding, or by adhering a snap feature to the sheet material. Other methods of manufacture can be found in U.S. provisional patent application 60/547,212, filed Feb. 24, 2004, the entire contents of which are hereby incorporated by reference.

The male fastener elements may be integrally molded with the sheet-form base, as discussed above, or may be post-applied. For example, a thin sheet material carrying an array of male fastener elements may be laminated to a sheet-form base carrying a snap feature.

The CD holder may be made of any desired material. Generally, thermoplastic resins are preferred. Suitable thermoplastic resins include polypropylene, polyethylene, polyamides and the like.

Other embodiments are within the scope of the following claims.

For example, the snap feature 18 shown in FIG. 1 can be replaced by other types of features configured to releasably hold a disc.

As one example, referring to FIGS. 4-4B, a CD holder 50 includes a snap feature 52 that is comprised of a plurality of cylindrical pillars 54 extending outwardly from surface 55 of base 56. As discussed above, base 56 carries a plurality of male fastener elements 58 on its opposite surface 60 (FIGS. 4A-4B). Cylindrical pillars 54 include a conical tapered camming surface 62, and are angled outward from the center of the holder at an angle A (FIG. 4B) of approximately 1-20 degrees, e.g. 5-10 degrees. When a user presses a CD 64 (FIG. 4A) against the tips of pillars 54, the walls of the central opening of the CD slide against camming surface 62, deflecting the pillars 54 towards a vertical position (perpendicular to the base), in which their tips define a circle having a diameter slightly smaller than the diameter of the central opening. Thus, the CD slides down over the snap feature 52. When the CD is close to the base of pillars 54, the pillars then resiliently deflect outward to their normal position (extending at an angle A relative to the vertical), thereby holding the CD in place by an interference fit. If desired, the cylindrical portion of pillars 54 may be slightly conical, tapering upward from a wider base to a slightly narrower top, to facilitate molding. In this case, it may be desirable to choose an angle A at the high end of the ranges discussed above, to compensate for the opposite angle of the taper.

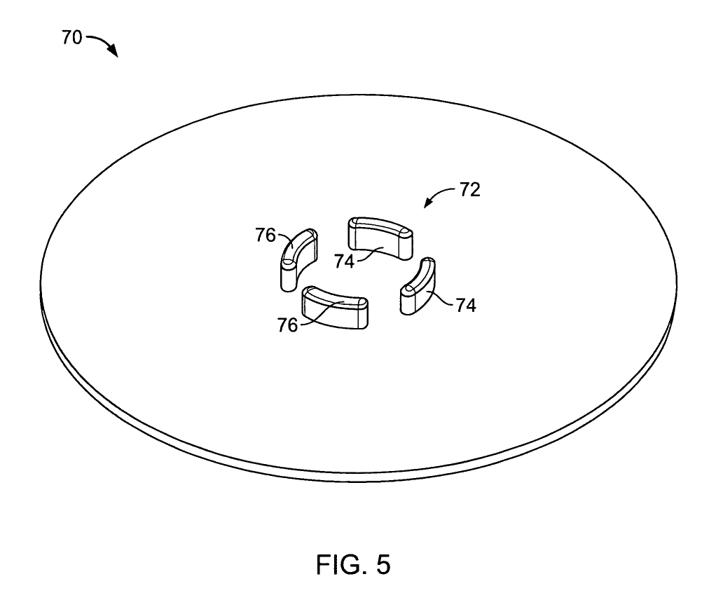

In another alternative embodiment, shown in FIG. 5, a CD holder 70 includes a snap feature 72. Instead of a plurality of cylindrical pillars, snap feature 72 includes four arcuate ridges 74, disposed so as to define a generally circular feature. Like the cylindrical pillars discussed above, ridges 74 include tapered camming surfaces 76, over which the walls of the central opening of a CD can slide. Thus, snap feature 72 functions in generally the same manner as snap feature 52, discussed above. As discussed above with reference to pillars 54, ridges 74 may taper slightly from base to tip, to facilitate molding.

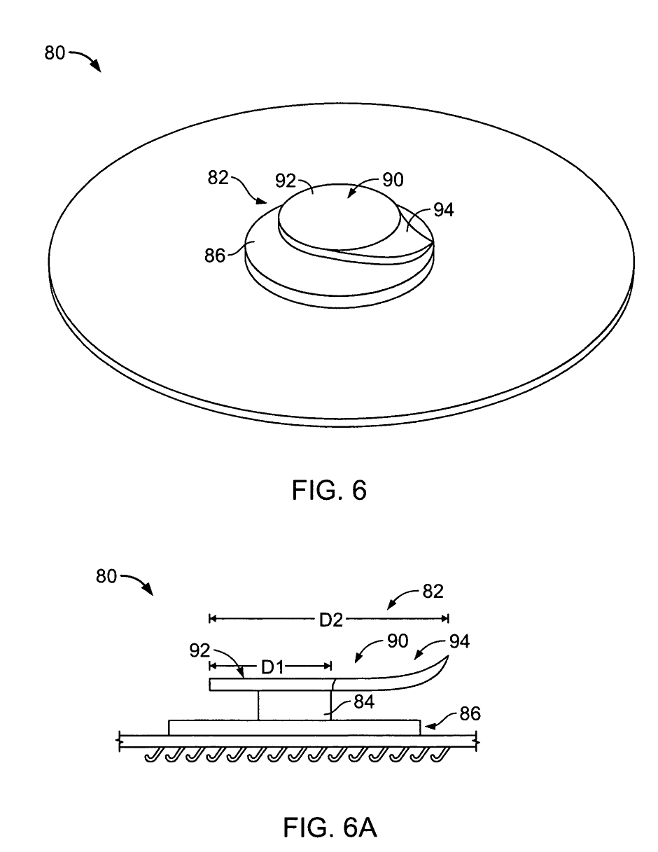

In a further alternative embodiment, shown in FIGS. 6-6A, a CD holder 80 includes a retention feature 82. Retention feature 82 includes a cylindrical post 84 (FIG. 6A), a spacer 86, between the cylindrical member 84 and base 88, and a head 90. Head 90 includes a planar portion 92 and a curved guide portion 94. A CD can be mounted on the CD holder by holding the CD at an angle, inserting the guide portion 94 of the retention feature 82 up through the central opening in the CD, and sliding the CD down and to the left (referring to FIG. 6A) until the CD is seated on post 84. In this position, the CD is free to spin on post 84 and to move transversely, to an extent determined by the difference between the diameter of post 84 and the diameter of the opening in the CD, but cannot fall off of post 84 due to head 90. The CD can be removed by gently sliding the CD first to the left (referring again to FIG. 6A), to slide the opening of the CD over the rim of planar portion 92, and then sliding the CD to the right, to remove guide portion 94.

Generally, the planar portion 92 will have a diameter D1 that is slightly smaller than the diameter of the central opening, e.g., 10 to 15 mm, while the overall diameter D2 of head 90 is significantly greater than the diameter of the central opening, e.g., 17 to 25 mm. The diameter D3 of post 84 should generally be smaller than D1 and significantly smaller than the diameter of the opening in the center of the CD. Thus, it is generally preferred that D3 be from about 4 to 10 mm. The spacer 86 provides a space between the surface of the CD and the base, to prevent scratching of the CD if the CD spins around the post 84 during storage on the CD holder. Spacer 86 may have a thickness, for example, of from about 0.5 to 2 mm.

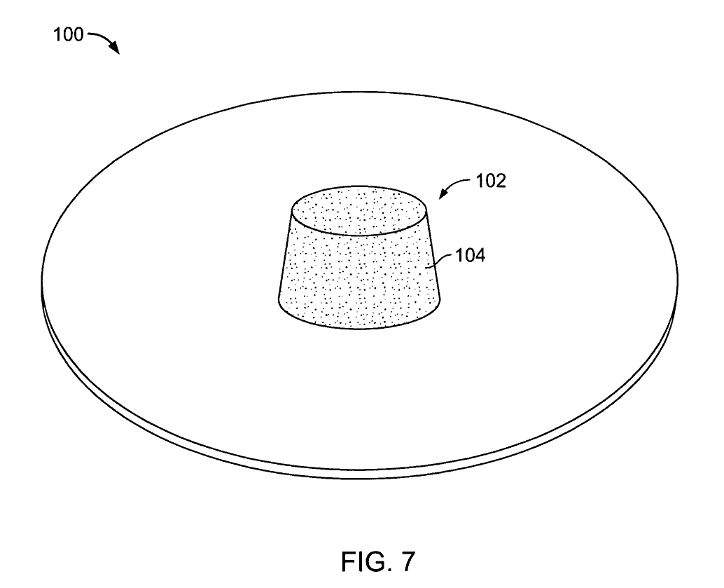

In another embodiment, shown in FIG. 7, a CD holder 100 includes a retention feature 102 in the form of a foam plug 104. As shown in FIG. 7, the foam plug 104 may be frustroconical, i.e., the side wall of the foam plug may taper gradually, to allow the wall of the central opening of the CD to slide easily over the surface of the plug. Alternatively, the side wall of the foam plug may be perpendicular to the base, i.e., the foam plug may be cylindrical. An open or a closed cell foam may be used. Suitable foams have sufficient resiliency and compressibility to allow the plug to securely and releasably retain CDs in the manner discussed above. Typically, it is preferred that the diameter of the foam plug at its top surface be slightly smaller than the diameter of the opening in the CD, e.g., 14-14.9 mm, and the diameter of the foam plug at its base be significantly greater than the diameter of the opening, e.g., 17-18 mm.

While the CD holders are shown and discussed above as being applied to the headliner of a vehicle, the CD holders can be applied to any desired surface that provides a hook-engageable surface for engagement with the male fastener elements on the CD holder. For example, the CD holders may be mounted on the walls of a fabric-covered cubicle. The CD holders may also be mounted on non-fabric-covered surfaces, if a female fastener component is provided on the surface.

Moreover, while the CD holders shown above are generally round, the CD holders may have any desired shape, e.g., square, rectangular, oval, star-shaped, or diamond-shaped.

While the CD holder has been shown holding a single CD, the CD holder can be adapted to hold a stack of two or more CDs. In this case, it may be desirable to increase the height and/or the engagement strength of the snap feature. For example, in the embodiment shown in FIG. 3, it may be desirable to increase the length that fingers 22 extend above the surface of the sheet-form body in order to accommodate additional CDs.

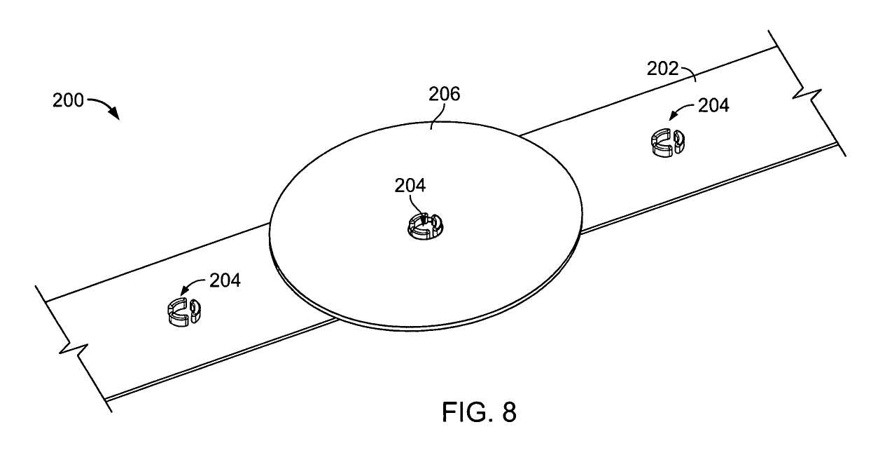

Similarly, multiple CDs can be accommodated by providing a CD holder 200, shown in FIG. 8, in which the base is comprised of an elongated strip or tape 202 which carries a row of snap features 204. The snap features 204 are sufficiently spaced apart so that each snap feature 204 can carry a CD 206 without the adjacent CDs touching. (A single CD is shown in FIG. 8, for clarity.) The base can have any desired shape, e.g., rather than being in the form of an elongated strip or tape the base can be a circular, square, oval or rectangular sheet carrying an array of snap features.

While holders for CDs are shown and described above, the holder can be adapted to hold any desired type of digital media disc, e.g., a DVD, simply by adjusting the dimensions of the holder as needed.

1. A holder for one or more digital media disc(s), comprising:
a base;
a feature configured to releasably hold a disc, extending from a first surface of the base; and
an array of fastener elements extending from a second, opposite surface of the base, the fastener elements being configured to engage a fabric substrate.

2. The holder of claim 1 wherein the fastener elements comprise male fastener elements.

3. The holder of claim 1 wherein the feature is configured to hold a plurality of discs.

4. The holder of claim 1 further comprising one or more additional features, extending from the first surface of the base at spaced intervals and configured to hold additional discs.

5. The holder of claim 1 wherein the fastener elements extend integrally from the base.

6. The holder of claim 2 wherein the fastener elements comprise hooks.

7. The holder of claim 1 wherein the base has a diameter smaller than the diameter of the disc.

8. The holder of claim 1 wherein the feature comprises a snap feature configured to extend through a central opening in the disc.

9. The holder of claim 6 wherein the snap feature comprises a plurality of resilient fingers.

10. The holder of claim 1 wherein the feature comprises a compressible foam.

11. The holder of claim 1 wherein the feature has a height of at least about 0.5 mm.

12. The holder of claim 1 wherein the feature has a height of about 1 to 5 mm.

13. The holder of claim 1 wherein the base has a thickness of about 0.5 to 5.0 mm.

14. The holder of claim 1 wherein the feature extends integrally from the sheet-form base.

15. The holder of claim 1 wherein the fastener elements are configured to be releasable from the substrate.

16. A method of securing one or more digital media disc(s) to a fabric substrate comprising
releasably securing a holder having a first surface bearing an array of male fastener elements to the substrate, by engaging the male fastener elements with loops extending from the substrate; and
releasably mounting the disc(s) on a second surface of the holder.

17. The method of claim 16 wherein the second surface includes a snap feature configured to extend through a central opening in the disc.

18. The method of claim 17 wherein the snap feature comprises a plurality of resilient fingers.

19. The method of claim 17 wherein the snap feature comprises a compressible foam.

20. The method of claim 17 wherein the snap feature extends integrally from the sheet-form base.

21. The method of claim 16 wherein the fabric substrate comprises the headliner of a vehicle.

22. The method of claim 16 wherein the fabric substrate comprises the wall of a cubicle.

23. The method of claim 16 wherein the male fastener elements comprise hooks.

24. A method of securing one or more digital media disc(s) to a loop-bearing substrate comprising
releasably securing a holder having a first surface bearing an array of male fastener elements to the substrate, by engaging the male fastener elements with loops extending from the substrate; and
releasably mounting the digital media disc(s) on a second surface of the holder.

25. The holder of claim 2 wherein said fastener elements comprise mushrooms.

26. The holder of claim 1 wherein the fastener elements comprise loop-engageable elements.
